(19) United States
(12) Patent Application Publication
(10) Pub. No.: US 2012/0247344 A1
(43) Pub. Date: Oct. 4, 2012

(54) METHOD AND APPARATUS FOR RAPID PRODUCTION OF INJERA BREAD

(76) Inventor: Michael Ma, (US)

(21) Appl. No.: 13/076,106

(22) Filed: Mar. 30, 2011

(51) Int. Cl. B65D 88/54; B67D 7/06

(52) U.S. Cl. 99/352; 222/251

(57) ABSTRACT

A dispensing mechanism is described for rapid and efficient production of injera bread. A flour/water batter mix is dispensed from a holding tank through a dispensing slot onto a conveyor belt, for transport to cooking and packaging stages. The holding tank may dispense onto the interior of a rotating drum type pierced with hole patterns through which the batter flows in the proper shape on to the conveyor belt, or the batter may pass through an oscillating plate with a half-moon pattern that forms injera patties on the belt.

### BACKGROUND

1. Technical Field

The invention relates to methods of rapid forming and baking of flatbreads, specifically Ethiopian bread known as injera.

2. DESCRIPTION OF THE PRIOR ART

Injera is a flatbread originating from the country of Ethiopia, where it is a staple of the diet. Typically, the bread is cooked on a fire-heated clay plate, which consumes vanishing wood resources in a dry and poor area. Approximately 75% of the total energy consumed in Ethiopian households is for baking and cooking, and 95% of this energy comes from wood or other biomass. The forest cover in Ethiopia has dropped in the past 50 years from 50% of the country to less than 3%. Mass production of injera would relieve many households of the energy required to bake it individually, and use energy far more efficiently.

The sole successfully implemented machine for mass production of injera is described in U.S. Pat. No. 7,063,008 (Admassu), with a maximum capacity of 1000 injera per hour. This design is complex, with a large number of complex parts, numerous production stages with stop/start cycles (with stops), and requiring two motors, three different heating elements and an air compressor to spread the raw batter and cool the cooked product. Such a complex machine likely has a high risk of breakdown requiring availability of skilled technicians, unlikely in a rural, poor country.

A simpler machine is desirable for the above reasons.

### SUMMARY

The invention provides a method and apparatus for rapidly producing injera and other flatbreads by means of a simple dispensing mechanism depositing a flour/water mix onto a conveyor belt for transport to cooking and packaging stages. The mechanism includes a tank with dispensing slot, either in the form of a rotating drum or a fixed tank with oscillating pattern plate.

### BRIEF DESCRIPTION OF THE DRAWINGS

FIG. 1 depicts an example injera production line;

FIG. 2 depicts a rotating drum embodiment of the batter dispenser;

FIG. 3 depicts a side view of the rotating drum embodiment;

FIG. 4 shows an oblique view of the rotating drum embodiment;

FIG. 5 depicts an embodiment using a fixed tank with oscillating plate; and

FIG. 6 shows a side view of the fixed tank embodiment.

### DESCRIPTION

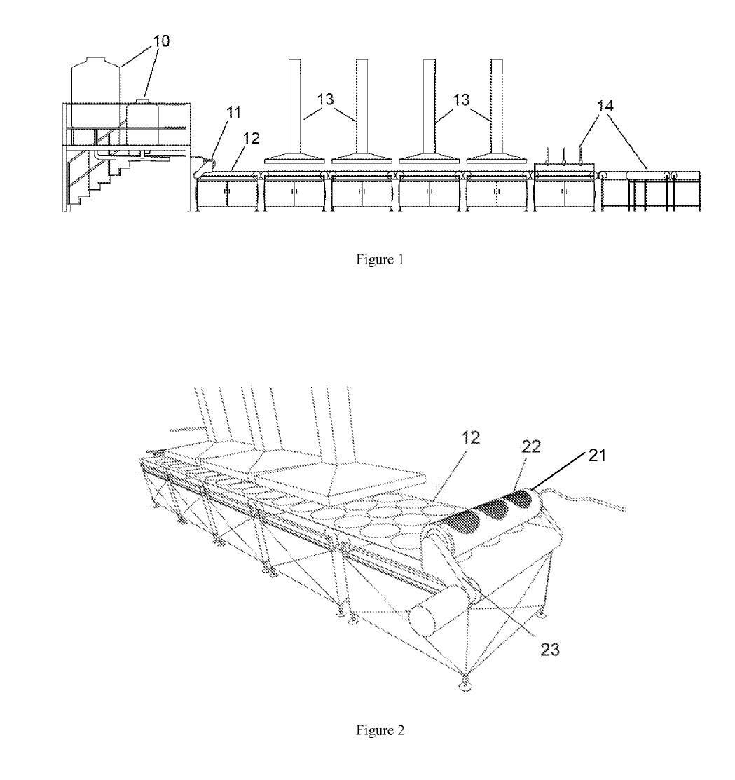

The invention comprises a production apparatus for injera bread, specifically a device for dispensing the flour/water mixture comprising injera onto a conveyor belt. FIG. 1 depicts an example injera production line, with flour and water stored in tanks 10. The ingredients are mixed and fed to the dispensing device 11, with the injera patties deposited onto the conveyor belt 12. The patties are then cooked by radiant heaters 13 and passed to cooling and packaging stages 14.

### Rotating Drum Embodiment

FIG. 2 depicts a rotating drum embodiment of the batter dispenser. A flour/water batter is fed through a cylindrical drum 21, with a rotational axis parallel to a horizontal conveyor belt 12. The surface of the drum, which is approximately one inch above the conveyor belt, is perforated with circular patterns of holes 22. These holes form a set of several circles across the width of the drum, with each circle approximately 15 inches in diameter.

The outer surface is rotated by means of a flexible belt or chain drive 23 affixed at one end, with the other end driven by a pulley or gear on the conveyor belt. The relative diameters of the drives on the belt and drum are sized so as to ensure the velocity of the surface of the drum matches the speed of the belt.

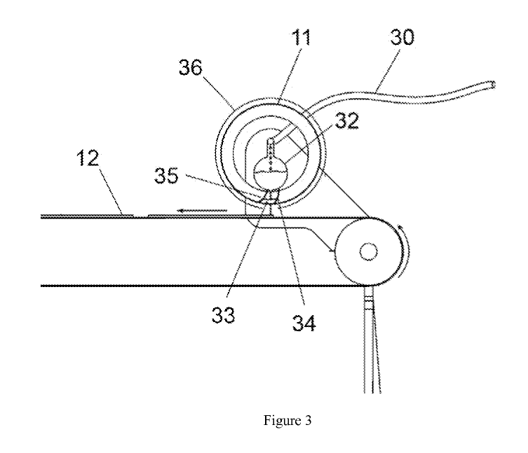

FIG. 3 depicts a side view of the rotating drum embodiment. A flour/water batter is fed from the holding tanks via tube or pipe 30 into one end of the drum, where it fills under pressure a linear compartment 32 located inside and along the length of the drum. This compartment is fixed in a stationary position relative to the rotating drum. The bottom of the batter compartment has at least one opening 33 from which the mix may flow to the holes perforating the drum.

Affixed to one side of the compartment is a flat spreading surface or squeegee 34 extending adjacent to the rotating drum surface, angled such that the surface is underneath the compartment openings. The batter flowing from the bottom of the compartment spreads across this surface, forming an even layer that contacts the holes in the drums. The batter then flows through the drum holes onto the conveyor. A scraper plate 35 or solid metal roller is affixed to the side of the batter compartment opposite from the spreading surface, and forces excess batter through the holes of the drum. A stationary shield 36 surrounds the rotating drum, covering moving parts and preventing spray of excess batter.

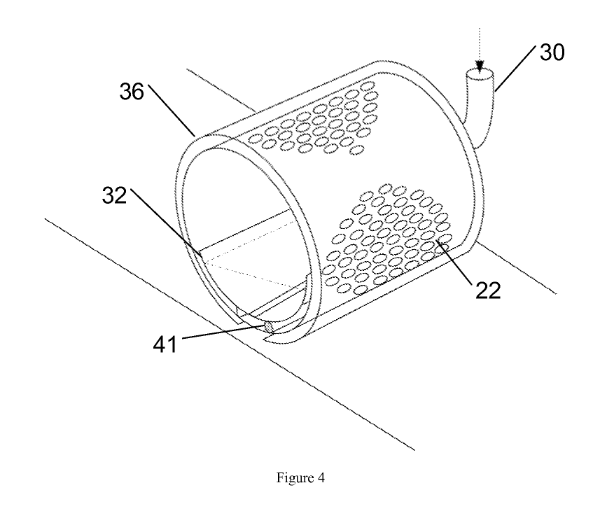

FIG. 4 shows an oblique view of the rotating drum embodiment, with feeding tube 30, stationary batter compartment 32, drum pattern holes 22, stationary shield 36, and solid metal roller 41.

As the batter exits the drum perforations, it is deposited onto the conveyor belt below, forming circular dough patties. As depicted in FIG. 1, the patties are then carried through the heating stage, where they are cooked by two to four heating elements 13 at two different temperatures to achieve the desired texture and consistency. Next, the conveyor belt carries the cooked injera through a cooling stage 14 where it is exposed to an air blast to prepare it for packaging. Finally, the cooled injera is routed to work stations for manual packaging.

The invention has several advantages over the prior art. It is designed to produce 5400 injera per hour vs. 1000 per hour, and promises more reliability due to fewer parts and more basic technology. Thus, opportunities for breakdown are reduces and the ability to be maintained by the unskilled labor available in Ethiopia is enhanced. Over Admassu, improved efficiency is realized through five times higher throughput, reduction of motors required from two to one, a continuously moving conveyor belt with no stop/start cycles, reduction of heating elements from three to two, and no air compressor required.

Stationary Tank with Oscillating Plate Embodiment

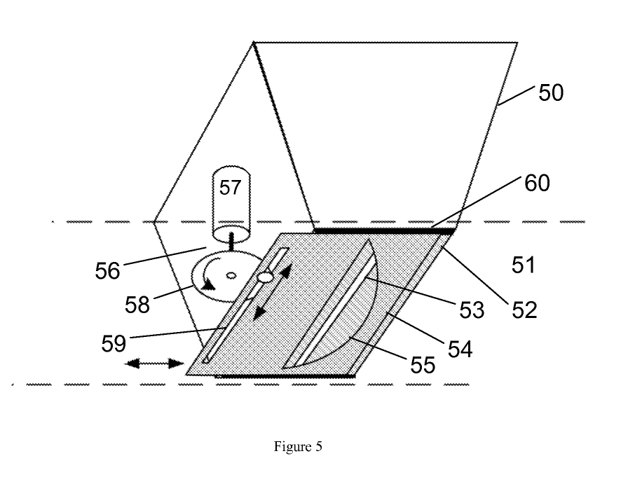

FIG. 5 depicts an embodiment using a fixed tank with oscillating plate. The fixed tank 50 is positioned across the width of the conveyor belt 51 (outlined from underneath), which is preferably at least 48 inches wide. The tank is comprised of metal plate, such as stainless steel, welded or riveted to form the tank shape.

A fixed plate 52 forms the bottom of the tank, with a dispensing slot 53 cut across its width perpendicular to the conveyor belt.

Below the slot plate is a second plate 54, called a pattern plate, with a semicircular or half-moon pattern 55. This pattern plate is mounted on an oscillating mechanism 56, which moves the plate fore and aft along the axis of the conveyor belt, perpendicular to the dispensing slot in the tank. The pattern plate may be replaceable to allow alternative patterns.

At the beginning of the dispensing cycle, no holes are aligned with the slot, thus no batter flows. As the pattern plate moves forward, the leading edge of the half-moon opening appears under the slot, and batter flows via gravity through the holes onto the conveyor belt. The pattern of the holes continues to widen in a circular shape, until the equator of the pattern is reached. At that point, the oscillating mechanism reverses the motion of the pattern plate, such that the diameter of the half-circle decreases until again the solid portion of the pattern plate blocks batter from flowing through the dispensing slot above.

The oscillating mechanism can be accomplished through several well known methods. The preferred embodiment comprises an electric motor 57 turning a circular plate 58, attached via an off-center pin to a transverse slot 59 in the pattern plate. The pattern plate is mounted on drawer slides 60 or roller bearings, such that as the motor rotates, the plate is pushed back and forth in a linear motion. Additionally, the plate may be removed and replaced with plates with alternative hole patterns to vary the size, thickness and shape of the batter deposits.

Additional oscillatory methods may be used, such as a cam roller where the connecting rod is attached via a linkage to a pivot point on the pattern plate, or a servoed linear actuator actuated by a programmable controller.

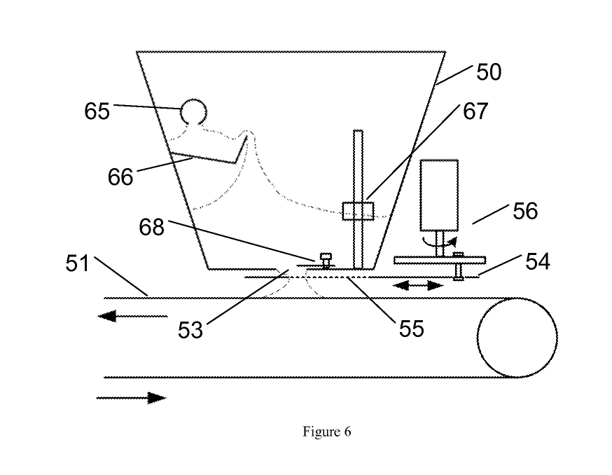

FIG. 6 shows a side view of the fixed tank embodiment. Batter flows through the feeder tube 65 onto a shallow transverse basin 66, where it overflows into the tank 50. A float cutoff 67 may be used to stop the flow of batter when the amount in the tank reaches a given level, triggering a closure valve either electrically or mechanically in the manner of a toilet tank mechanism. Additionally, a closure plate 68 may be adjusted to restrict or stop the flow of batter through the dispensing slot 53. As above, the oscillating mechanism 56 causes the pattern plate 54 to oscillate fore and aft, thus dispensing batter through the pattern 55 onto the conveyor belt 51.

What is claimed is:

1. An apparatus for dispensing injera batter, comprising:
a cylindrical drum supported on bearings and positioned over a conveyor belt;
a means for rotating said drum;
a means for conveying injera batter to the interior of said drum;
at least one aperture for conveying said batter from the interior of said drum; wherein
said conveyor belt receives batter from said drum for transport to a cooking stage.

2. The apparatus of claim 1, wherein said aperture consists of circular patterns of holes.

3. The apparatus of claim 1, wherein said batter is conveyed to a stationary compartment within the drum, containing an opening for passing said batter to said drum aperture.

4. The apparatus of claim 1, wherein the flow rate of said batter may be regulated by a movable shutter partially or wholly blocking said aperture.

5. The apparatus of claim 1, wherein a stationary spreading surface is fitted within said drum parallel to said aperture to help force said batter through said aperture.

6. The apparatus of claim 1, wherein a stationary shield is fitted closely around said rotating drum to prevent excess batter from being dispersed.

7. An apparatus for dispensing injera batter, comprising:
a fixed tank positioned over a conveyor belt;
a means for conveying injera batter to the interior of said tank;
a first plate forming the bottom of said tank with at least one first aperture to allow batter to exit said tank;
a second plate below said first plate with at least one second aperture, said second plate linked to an oscillating mechanism; wherein
said oscillating mechanism periodically aligns said first aperture and said second aperture, allowing said batter to be dispensed onto said conveyor belt for transport to a cooking stage.

8. The apparatus of claim 7, wherein said first aperture comprises a slot across the width of said tank, perpendicular to the direction of travel of said conveyor belt.

9. The apparatus of claim 7, wherein said second aperture comprises a semicircular or half-moon pattern.

10. The apparatus of claim 7, wherein said oscillating mechanism comprises a cam and connecting rod linking a rotary power source to said second plate.
